(19) United States
(12) Patent Application Publication
(10) Pub. No.: US 2017/0155289 A1
(43) Pub. Date: Jun. 1, 2017

(54) STATOR ELEMENT FOR AN ELECTRIC MOTOR

(71) Applicant: Robert Bosch GmbH, Stuttgart (DE)

(72) Inventors: Wolfgang Krauth, Achern-Sasbachried (DE); Tilo Koenig, Buehl (DE)

(21) Appl. No.: 15/300,178

(22) PCT Filed: Feb. 3, 2015
(86) PCT No.: PCT/EP2015/052141

§ 371 Date: Sep. 28, 2016

(30) Foreign Application Priority Data
Mar. 31, 2014 (DE) 102014205963.1

(51) Int. Cl. H02K 1/14; H02K 15/12; H02K 15/02

(52) U.S. Cl. CPC H02K 1/145; H02K 15/022; H02K 15/12

(57) ABSTRACT

The invention relates to a stator element (100) for an electric motor comprising: a defined number of claw poles (10, 20, 30, 40), said stator element (100) being heat treated during production, in the region of the Curie temperature of the stator element (100); said stator element (100) being cooled after the heat treatment.

### BACKGROUND OF THE INVENTION

The invention relates to a stator element for an electric motor. The invention further relates to a method for producing a stator element for an electric motor.

Electrically commutated electric motors having stators according to the claw pole principle are known in the prior art. In the case of such a stator, a magnetic flux that is emanating from a winding coil is collected and guided by means of claw poles in a radial manner to the rotor of the electric motor, wherein the rotor is penetrated by the magnetic flux. The claw poles are to guide the magnetic flux with the lowest possible losses and are generally manufactured from solid metal or from magnetic steel sheets. Alternatively, the claw poles can be manufactured from soft magnetic powder composite materials (SMC materials, soft magnetic composites). Reduced hysteresis losses can be achieved using the magnetic steel sheets and the SMC materials.

### SUMMARY OF THE INVENTION

It is the object of the invention to provide an improved stator element that is embodied according to the claw pole principle for an electric motor.

In accordance with a first aspect, the object is achieved by means of a stator element for an electric motor, comprising:
a defined number of claw poles;
wherein during the production process the stator element has undergone a heat treatment process in the range of the Curie temperature of the stator element;
wherein the stator element has subsequently undergone a cooling process after the heat treatment process.

It is possible by means of the heat treatment that is provided during the production of the stator element to improve or homogenize a grain structure within the stator element, wherein the magnetized resistance reduces. As a result, magnetic hysteresis losses can consequently be minimized, which advantageously supports an improved performance of the electric motor.

In accordance with a second aspect, the object is achieved by means of a stator element for an electric motor, comprising a defined number of claw poles, wherein the claw poles comprise bend radii that extend over a connection region having a claw pole ring, wherein the bend radii are larger in each case at the periphery of the claw poles than in the middle of the claw poles.

In accordance with a third aspect, the object is achieved by means of a method for producing a stator element for an electric motor, wherein the stator element comprises a defined number of claw poles, wherein the method comprises the following steps:
shaping and heating of the stator element; and
subsequently cooling the stator element.

An advantageous further development of the stator element is characterized by virtue of the fact that a temperature during the heat treatment process lies in a range between approx. 400° C. and approx. 1000° C. It is possible in this defined temperature range, depending upon the materials used to produce the stator element, to improve the properties of the stator element concerning the magnetic conductance.

A further embodiment of the stator element is characterized by virtue of the fact that the stator element has undergone a heat treatment process during a shaping process or after a shaping process. As a consequence, two alternative possibilities for heat treating the stator element are available in an advantageous manner.

A further embodiment provides that the stator element has undergone the shaping process in the form of a stamping and bending process. The material damage possibly created by the stamping and bending process can be reduced by means of the heat treatment process, as a consequence of which the conducting properties of the stator element for the magnetic flux are improved.

A further embodiment of the stator element provides that the stator element has undergone the cooling process in the form of reducing the temperature of a heating device, in which the stator element was arranged during the heat treatment process. In this manner, a particularly slow process of cooling the heated stator element can be achieved in an advantageous manner. As a result, a very secure and easily controllable cooling process can be provided.

A preferred embodiment of the stator element provides that the stator element has undergone a cooling process in the form of cooling at ambient temperature. In this manner, a relatively quick cooling process is provided, which can provide cost benefits.

A further preferred design of the stator element is characterized by virtue of the fact that the stator element, after having undergone a defined temperature drop in the first cooling phase, has undergone in a second cooling phase a cooling process by means of a higher temperature gradient than in the first cooling phase. As a consequence, it is therefore possible for the stator element to undergo various cooling phases in an advantageous manner, wherein various cooling rates can be implemented and, as a consequence, production processes can be optimized.

A further preferred embodiment of the stator element provides that the claw poles comprise bend radii that extend over a connection region having a claw pole ring, wherein the bend radii are larger in each case at the periphery of the claw poles than in the middle of the claw poles. In this manner, optimized bend radii are provided, said bend radii supporting an improvement of the magnetic flux and an increased mechanical stability of the stator element.

A further embodiment of the stator element is characterized by virtue of the fact that the material of the stator element is a metal or a magnetic steel sheet. The diversity of designs for the stator element is advantageously increased by means of the said different materials.

### BRIEF DESCRIPTION OF THE DRAWINGS

The invention is illustrated in detail hereinunder by means of further characteristics and advantages with reference to several figures. All described figures are the subject of the invention, irrespective of their presentation in the description and in the figures as well as in their back reference in the patent claims. The figures are to be understood merely qualitatively and serve in particular to explain the principles that are essential for the invention.

In the figures:

FIG. 1 illustrates a schematic presentation of a function principle of a stator in accordance with the claw pole principle;

FIG. 2 illustrates an exploded view of elements of a stator for an electric motor;

FIG. 3 illustrates a view of a conventional stator element in accordance with the claw pole principle;

FIG. 4 illustrates a view of a further conventional stator element in accordance with the claw pole principle;

FIG. 5 illustrates an embodiment of the stator element in accordance with the invention in accordance with the claw pole principle; and

FIG. 6 illustrates a principle sequence of an embodiment of the method in accordance with the invention.

### DETAILED DESCRIPTION

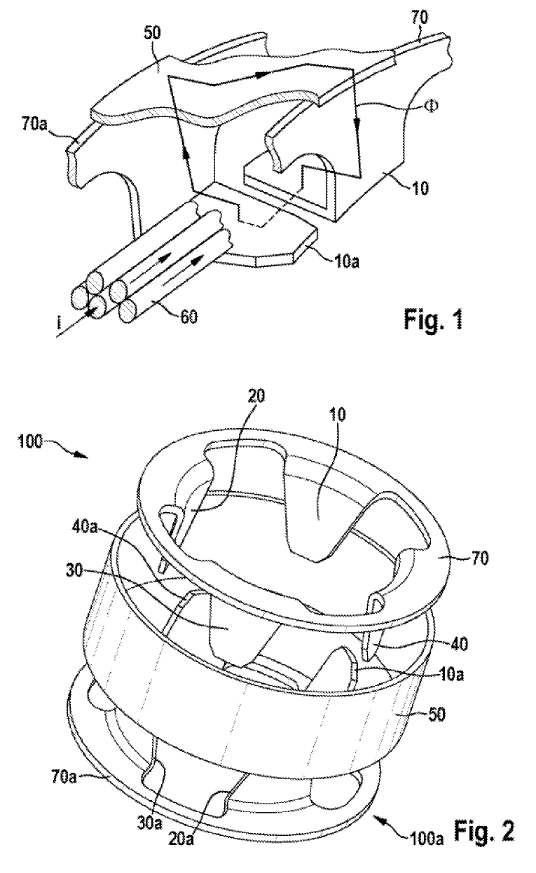

FIG. 1 illustrates in a schematic manner a known construction of a stator for an electric motor (not illustrated) in accordance with the claw pole principle. An electric alternating current is thereby conducted cyclically alternating in the illustrated direction and in the direction opposite to the illustrated direction through windings 60. As a consequence, the magnetic poles north and south form on claw poles 10, 10a of different stator elements 100, 100a in a cyclically alternating manner, wherein the claw poles 10, 10a are arranged in each case on a different claw pole ring 70, 70a. The in-part dashed line of the closed magnetic flux Φ is intended to indicate that the magnetic flux Φ extends in the region of the dashed line through a rotor (not illustrated) of the electric motor.

FIG. 2 illustrates in a 3D exploded view an image of two stator elements 100, 100a that are embodied in accordance with the claw pole principle and comprise in each case four claw pole rings 10, 20, 30, 40 or 10a, 20a, 30a, 40a and of a magnetic coil flux guide ring 50. Hereinunder, solely the elements of the first stator element 100 will be described in detail for the sake of simplicity, wherein a structure of the second stator element 100a is identical to that of the first stator element 100. The claw poles 10, 20, 30, 40 are integrally connected to a claw pole ring 70, wherein the claw poles 10, 20, 30, 40 are bent inwards starting from claw pole ring 70, wherein the claw pole ring 70 represents a supporting frame of the stator element 100. All the elements illustrated in the figure are preferably manufactured from magnetic steel sheets. An entire arrangement that comprises the two stator elements 100, 100a and the coil flux guide ring 50 and is injection molded with a synthetic material forms the basic structure of a stator device for an electric motor according to the claw pole principle.

There are several possibilities with regard to the positioning and mounting of the claw poles 10, 20, 30, 40 and of the coil flux guide ring 50. For example, it is known that the two stator elements 100, 100a are injection molded with a synthetic material (for example glass fiber reinforced polyamide, not illustrated), wherein an electric isolation of the winding 60 (not illustrated in FIG. 2) is formed simultaneously. The coil flux guide ring 50 is embodied in a manner that is essentially free of play lying against the stator elements 100, 100a in the form of the claw pole metal sheets.

The claw poles 10, 20, 30, 40 of the stator element 100 are manufactured from magnetic steel sheet during the production process by way of a stamping and bending process and are consequently injection molded with a glass fiber reinforced polyamide. During each bending process, the component is clinched at the inner radius and stretched at the outer radius. The so-called ‘neutral fiber’ is located in the center, said neutral fiber remaining essentially unchanged by means of the bending process in terms of length. In the case of the illustrated claw metal sheets and the said reshaping or shaping process, this is also the case in the tangential center of every claw pole 10, 20, 30, 40.

As a consequence of the fact that the bend lines for the claw poles 10, 20, 30, 40 do not run in a straight line but rather in a curved line, a dimension-related stretching process is performed in addition to the clinching and stretching during the bending process. This can further enhance the change in the grain structure of the magnetic steel sheet, said change occurring in any case during the bending process. This can be disadvantageous for a magnetic conductivity, which can mean increased magnetic losses. Furthermore, the material becomes thinner as a result of the additional stretching process. The reduced cross sections in the claw metal sheets can in turn limit a performance of the motor in a disadvantageous manner.

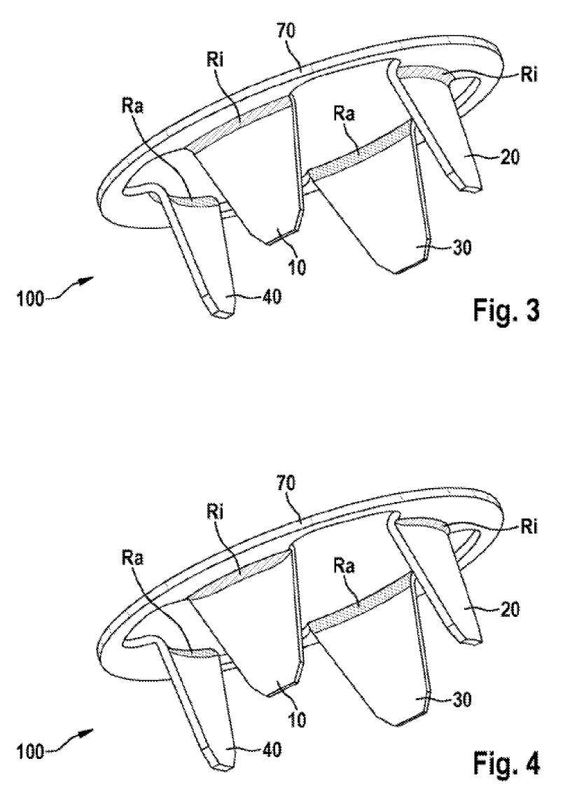

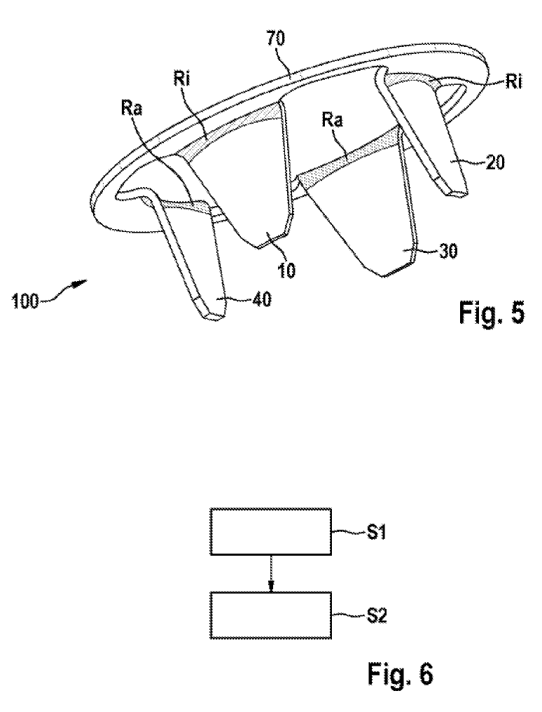

During the operation of the electric motor, all magnetic field lines that are involved in the generation of the magnetic torque of the electric motor pass through the radii marked in FIG. 3 (region between outer radius Rₐ and inner radius Rᵢ). The outer radii Rₐ describe bend radii on the surfaces (upper faces) of the claw poles 10, 20, 30, 40, said upper faces being remote from the claw poles 10, 20, 30, 40 in the bend direction. The inner radii Rᵢ describe bend radii on the surfaces (lower faces) of the claw poles 10, 20, 30, 40, said lower faces facing the claw poles 10, 20, 30, 40 in the bend direction. By way of the said heat treatment process, the magnetic permeability μ improves, in particular between the regions Rₐ and Rᵢ, which are those regions that have been damaged during the preceding stamping and bending process in particular with regard to the grain structure.

During the process of producing the claw metal sheets or injection molding the claw metal sheets with synthetic material, it can be expedient from the point of view of the production process that, as is evident in FIG. 4, the inner radius Rᵢ becomes increasingly smaller towards the peripheries of the claw poles 10, 20, 30, 40. For example, the inner radius Rᵢ in the center of the claw poles 10, 20, 30, 40 can be approximately 1 mm, however it can be very small at the periphery, which corresponds essentially to forming an edge. This can lead to greatly pronounced damage to the grain structure of the material, wherein a control of the magnetic flux Φ can be disadvantageously very impaired. Furthermore, as a result of this small radius in the peripheral areas of the claw poles 10, 20, 30, 40, the material can be mechanically loaded at that site in such a way that it can lead to an increased tendency to crack and a reduced stability.

It is therefore proposed in accordance with the invention to subject the stator element 100 to a heat treatment process during the course of the production of the stator element 100, wherein the magnetic permeability μ (magnetic conductivity) of the stator element 100 can be significantly improved. This renders it possible to eliminate or reduce any negative effects that arise in the grain structure as a result of the said shaping process, wherein the magnetic losses can be reduced and the performance of the electric motor can be increased.

It is advantageously possible in this manner to provide an increased magnetic flux whilst reducing magnetic losses in the claw poles 10, 20, 30, 40 of the stator element 100. This can be utilized in an advantageous manner to achieve an improved efficiency of the electric motor, to increase the performance and/or to reduce the amount of installation space for the electric motor. As a consequence, the required electric currents and the thermal losses can be reduced in an advantageous manner whilst maintaining an identical level of performance.

It has emerged that in order to achieve a fullest possible potential of the heat treatment process, the Curie temperature (for example approximately 745° C. in the case of the magnetic steel sheet M250-50A) can be exceeded whilst excluding air and the stator element 100 should be subjected to a subsequent cooling process. It is preferred that the said heat treatment process of the stator elements should be implemented at least in the range of the Curie temperature. For the said magnetic steel sheet, the first number (250) is a measure of the magnetic losses and the second number is a measure of the thickness of the metal sheet, in this case 0.5 mm. Significant improvements to reference sections, said improvements increasing according to temperature, have been measured in test series using various metal sheets and temperatures.

Furthermore, it has emerged that heat treatment processes between approximately 400° C. and approximately 1000° C. can lead to crucial improvements of the magnetic flux properties of the material of the stator element 100. Consequently, improvements occur namely at all said temperatures, said improvements being yet more pronounced the higher the chosen temperature. By way of example, a holding period, in other words a dwell period of the stator element 100 in the oven, can amount to only a few minutes per millimeter wall thickness.

Furthermore, it has emerged that the choice of a cooling rate can have an influence on the improvements relating to the materials used in the stator element. As a standard, the significantly improved material properties can be supported by means of a slow cooling process. Alternatively, it is also possible to simply remove the heated stator element 100 from a heating device (for example an oven) and to let it cool at room temperature or ambient temperature. Alternatively, it is also possible that it is cooled during the cooling process after a defined temperature drop (for example to the extent of approximately 50%) in a second cooling phase having a higher gradient than in the preceding first cooling phase. This can be performed by way of example by means of a blower. Although a very slow cooling process generally delivers the best results, it can be advantageous to perform a faster cooling process that is also more cost efficient with regard to the whole production process.

Furthermore, it can be provided that the original state survives in the middle of the claw poles 10, 20, 30, 40 yet the radii Rₐ, Rᵢ continuously increase towards the periphery of the claw poles 10, 20, 30, 40. This leads to the lengths of the neutral fibers being virtually independent from their tangential position, wherein it is achieved that the material essentially no longer stretches differently in dependence upon the tangential position. The disadvantageous, position-dependent reduction of the wall thickness is virtually eliminated in this manner. As a result, the line properties for the magnetic flux Φ can be optimized or at least improved in an advantageous manner.

The said measures advantageously result in a greater wall thickness in the critical regions of the claw pole metals sheets, wherein the damage to the grain structure of the magnetic steel sheets is less.

By means of this specific geometric design of the stator elements 100, 100a there can be a marginal increase in some regions of the air gap between rotor and stator (not illustrated), that can lead to a poorer motor performance. However, this only represents a very small proportion in relation to the entire air gap and is incommensurate with performance gain that is feasible in accordance with the principle in accordance with the invention.

FIG. 6 illustrates in principle a sequence of the method in accordance with the invention.

In a first step S1, the stator element 100 is shaped and heated.

Finally, in a second step S2, the stator element 100 is subsequently cooled.

In summary, a stator element for an electric motor is proposed with the present invention, said stator element comprising significantly improved magnetic properties. As a result, an improved performance of the electric motor is consequently supported. This is achieved by means of a specific heat treatment process in the range of the Curie temperature of the material used in each case.

It is self-evident that the invention has been described above with reference to specific exemplary embodiments and that the invention is not restricted to the described exemplary embodiments. The person skilled in the art will recognize that a plurality of variations of the above described features, in particular with regard to material selection, to a number of the claw poles etc. is possible without deviating from the core of the invention.

1. A stator element (100) for an electric motor comprising:
a defined number of claw poles (10, 20, 30, 40);
wherein the stator element (100) has been subjected during a production process to a heat treatment process in a region of the Curie temperature of the stator element (100); and
wherein the stator element (100) has been subjected to a cooling process after the heat treatment process.

2. The stator element (100) as claimed in claim 1, characterized in that a temperature of the heat treatment process lies in a range between approximately 400° C. and approximately 1000° C.

3. The stator element (100) as claimed in claim 1, characterized in that the stator element (100) has undergone the heat treatment process during a shaping process or after a shaping process.

4. The stator element (100) as claimed in claim 3, characterized in that the stator element (100) has undergone a shaping process in the form of a stamping and bending process.

5. The stator element (100) as claimed in claim 1, characterized in that the stator element (100) has undergone the cooling process in the form of reducing the temperature of a heating device, in which the stator element (100) was arranged during the heat treatment process.

6. The stator element (100) as claimed in claim 1, characterized in that the stator element (100) has undergone the cooling process in the form of a cooling process at ambient temperature.

7. The stator element (100) as claimed in claim 6, characterized in that the stator element (100), after having undergone a defined temperature drop in a first cooling phase, has undergone a cooling process at a higher temperature gradient in a second cooling phase.

8. The stator element (100) as claimed in claim 1, characterized in that the material of the stator element (100) is a metal or a magnetic steel sheet.

9. A stator element (100) for an electric motor, comprising a defined number of claw poles (10, 20, 30, 40), wherein the claw poles (10, 20, 30, 40) comprise bend radii (Rₐ, Rᵢ) that extend over a connection region having a claw pole ring (70), wherein the bend radii (Rₐ, Rᵢ) are larger in each case at the periphery of the claw poles (10, 20, 30, 40) than in the middle of the claw poles (10, 20, 30, 40).

10. A method for producing a stator element (100) for an electric motor, wherein the stator element (100) comprises a defined number of claw poles (10, 20, 30, 40), wherein the method comprises the following steps:
shaping and heating of the stator element (100); and
subsequently cooling the stator element (100).

11. The method as claimed in claim 10, wherein the heating process is essentially performed simultaneously with the shaping process or after the shaping process.

12. The method as claimed in claim 10, wherein the shaping process is a stamping and bending process.

13. (canceled)

14. A method for producing a stator element (100) for an electric motor, wherein the stator element (100) comprises a defined number of claw poles (10, 20, 30, 40), wherein the method comprises the following steps:
subjecting the stator element (100) to a heat treatment process in a region of the Curie temperature of the stator element (100); and
subjecting the stator element (100) to a cooling process after the heat treatment process.

15. The method as claimed in claim 14, characterized in that a temperature of the heat treatment process lies in a range between approximately 400° C. and approximately 1000° C.

16. The method as claimed in claim 14, further comprising subjecting the stator element (100) to the heat treatment process during a shaping process or after a shaping process.

17. The method as claimed in claim 16, wherein the shaping process is a stamping and bending process.

18. The method as claimed in claim 14, wherein the cooling process includes reducing the temperature of a heating device, in which the stator element (100) was arranged during the heat treatment process.

19. The method as claimed in claim 14, wherein the cooling process includes cooling at ambient temperature.

20. The method as claimed in claim 19, further comprising subjecting the stator element (100), after having undergone a defined temperature drop in a first cooling phase, to a second cooling phase at a higher temperature gradient.

21. The method as claimed in claim 14, characterized in that the material of the stator element (100) is a metal or a magnetic steel sheet.
